(19) United States
(12) Patent Application Publication
(10) Pub. No.: US 2005/0111308 A1
(43) Pub. Date: May 26, 2005

(54) Display device with hinged stand

(76) Inventor: Michael Jackson Hosey, Fairview, NC (US)

Correspondence Address: Stuart Whittington, Esq., 7037 E. Monte Circle, Mesa, AZ, 85208, US

(21) Appl. No.: 10/719,537

(22) Filed: Nov. 20, 2003

(51) Int. Cl. G04B 37/00

(52) U.S. Cl. 368/317

(57) ABSTRACT

A timepiece includes a casing section enclosing a display device and an attachment section hingedly attached to the casing section. The timepiece is operable to be placed in a first configuration to attach a timepiece to an object of interest and in a second configuration for use as a tabletop clock.

### TECHNICAL FIELD OF THE INVENTION

This invention relates generally to display devices and, in particular, but not exclusively, to a timekeeping device attached to a clip, wherein the clip can pivot and act as a stand for the display device device.

### BACKGROUND OF THE INVENTION

Typically, timekeeping devices are worn on the wrists of a user. However, this is not always a convenient place to attach a timekeeping device. For example, during exercising or participating in outdoor activities such as hiking, biking and canoeing, a timekeeping device attached to the wrist may be uncomfortable, subject to damage, and an inconvenient location to observe the time. In addition, wrist bands often break at inopportune moments which increase the possibility of loosing the timekeeping device.

In response to this need, timekeeping devices with an integrated clip have been proposed. One such example is disclosed in U.S. Pat. No. 6,527,434 issued on Mar. 4, 2003 to Fox et al. and assigned to the Timex Group B.V. This timekeeping device consists of a single one-piece unit having a clip portion; the two sections are formed as a single, integrated unit. The clip portion includes a gate section that pivots about an axis to open and close the clip. The gate section is the only section that pivots in the timekeeping device. The clip section can be used to attach the timekeeping device to a backpack, clothes or sports equipment.

The timekeeping device of U.S. Pat. No. 6,527,434, while allowing a user to attach the timekeeping device to a user's clothes or sporting equipment suffers from several drawbacks. First, as a one-piece unit, it is inflexible and under an impact may be susceptible to breakage. Also, as an integrated unit, the timekeeping device of U.S. Pat. No. 6,527,434 is not readily usable in other situations and places, such as for use as a table top timekeeping device.

Accordingly, a timekeeping device that attaches to a user's clothing and/or equipment and that can be conveniently used as a desk or table timekeeping device is needed.

### SUMMARY OF THE INVENTION

In one embodiment, the present invention discloses a timepiece including a casing section enclosing a display and an attachment section hingedly attached to the casing section. The timepiece is operable to be placed in a first configuration for use as a timepiece attachable to an object of interest and in a second configuration for use as a tabletop clock.

In another embodiment, the present invention discloses an attachable display apparatus comprising a casing section enclosing a display area and an attachment section coupled (either fixed or detachable) to the casing section and operable to connect to an object of interest. The casing section and the attachment section can be configured to lie essentially in the same plane to form a first configuration and the casing section and the attachment section can be configured to form an angle of ninety degrees or less between the attachment section and the casing section to form a second configuration.

In one embodiment, the display is a liquid crystal display that is provided as part of a watch module. The watch model is capable of determining and/or displaying the current time, altitude, barometric reading, temperature, compass heading timed and or date.

In one embodiment, the attachment section is a carabiner clip. Optionally, the attachment section is any structure capable of connecting the casing to an item of interest and serving as a stand for the display. The display can be a digital display or any structure that can be installed inside the casing section for later viewing.

### BRIEF DESCRIPTION OF THE DRAWINGS

These and other aspects, features and advantages of the present invention will become apparent from the following description of the invention in reference to the appended drawing in which like numerals denote like elements and in which:

FIG. 1 is a view of the timepiece;

FIG. 2 is a side view of the right side of the timepiece with respect to the view of FIG. 1;

FIG. 3 is a view of the back of the timepiece;

FIG. 4 is a cut away view of the timepiece as shown in FIG. 1, taken along the line A-A; and

FIG. 5 is a view of the timepiece in a tabletop deployment.

### DETAILED DESCRIPTION OF THE DRAWINGS

A timekeeping device, in accordance with one or more embodiments of the present invention, provides a timepiece that can be attached and removed from clothing or equipment, such as backpacks. Also, the timepiece has an attachment mechanism that attaches to a casing at a hinged section such that the attachment section can be rotated to form a base to hold a display of the timepiece in an upright fashion, e.g., such that it can be used as a tabletop clock. While embodiments of the present invention describe a “timepiece” for simplicity, the invention is not limited thereto, as other non-time related displays may be implemented into the casing. For example, a multi-function display such as a GPS display, an MP3 player, AM/FM radio or other audio device, a personal medical device such as a heart rate monitor, a personal data assistant (PDA), cell phone, a FMR/GPRS/CB transceiver or other device could readably be substituted for a timekeeping device.

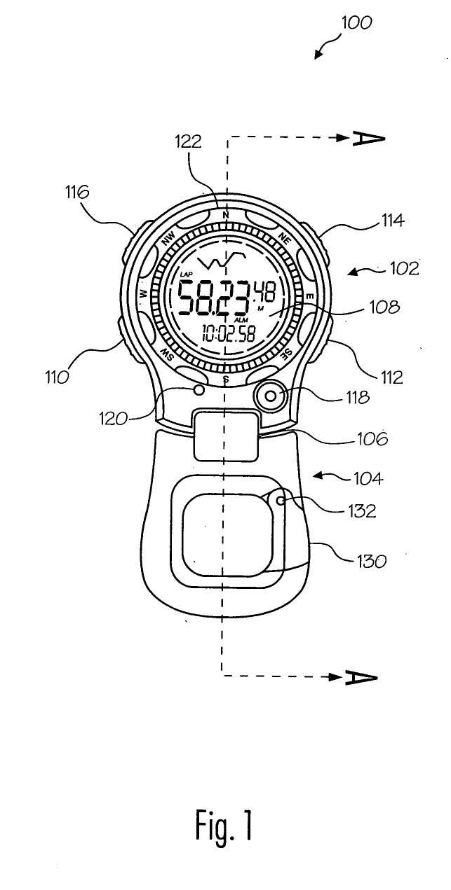

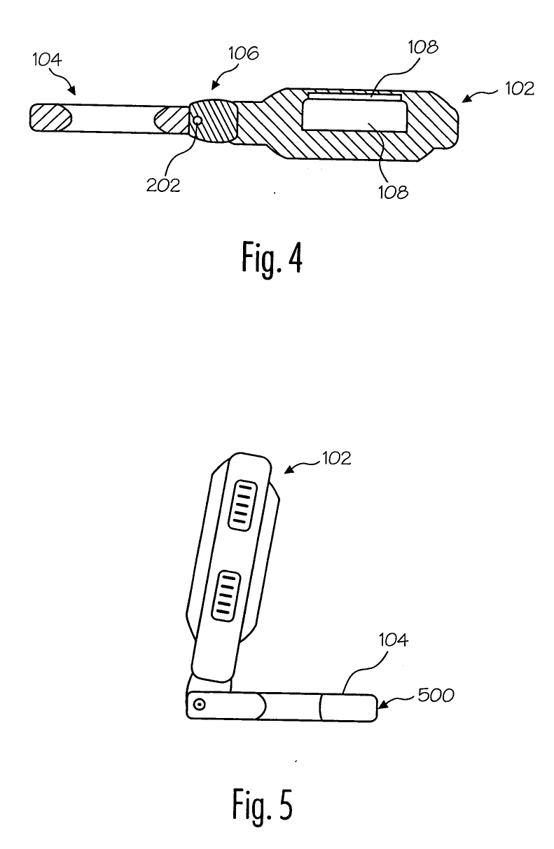

FIGS. 1-4 illustrate a timepiece 100. Timepiece 100 includes a casing section 102 and an attachment section 104 connected to the casing section 102 at a hinge section 106 such that either the attachment section 104 can rotate about an axis or the casing section 102 can rotate about an axis.

Casing section 102 contains and protects a display device 108 located on the front side 204 of the casing section 102. Display device 108 can be any structure capable of being stored in the casing section 102. In one embodiment, the display device 108 is a liquid crystal display (LCD) coupled to or integrated with an electronic watch module 402 which includes all of the necessary electronic and/or mechanical components to provide the needed functionality and present it to display device 108.

In one embodiment, display device 108 is an electronic watch module. Watch modules are commercially available from sources such as National Electronic Watch Company of Hong Kong. Display device 108 may also be a personal audio device such as a MP3 player or FM radio, a digital camera, a communication device such as a FMR transceiver or a cellular phone, and the like. Alternatively, display device 108 can be a structure for holding a photograph, collectibles, and the like.

In one embodiment, a battery compartment 302 is located on the backside 206 of the casing section 102. The battery compartment 302 contains the power source for the watch module 402. Casing section 102 can be manufactured from any suitable material such as stainless steel, aluminum, plastic or rubber. In one embodiment the casing section 102 is manufactured from plastic with an aluminum back. Casing section 102 is preferably water proof to at least 50 meters; however, a non water proof casing may also be used.

Casing section 102 may further include one or more buttons used to change/implement the functionality of timepiece 100. In one example embodiment, there is a first button 110, a second button 112, a third button 114 and a fourth button 116. Casing section 102 or display device 108 may further include an optional level 118 and/or a sensor 120. A bezel 122 may also be mounted around the display device 108. Level 118 is provided as an additional tool for a user. Sensor 120 is any apparatus capable of detecting an external condition and relaying the information to the watch module 402. In one embodiment sensor 120 is a temperature sensor that measures the temperature external to timepiece 100 for presentation on display device 108. Bezel 122 in one embodiment is a rotating bezel with directional indicia. This type of bezel, in conjunction with the digital compass, can be used for navigational purposes.

The following description of the functions of the watch module is for exemplary purposes only. Other functionalities can be added to the ones described below or functionalities described below can be removed.

In one embodiment, timepiece 100 includes several operational modes including a time mode, an altimeter mode, a barometer mode, a chronograph mode, a compass mode and an alarm mode. When in the time mode, the current time and/or time in other time zones is displayed. The altimeter mode displays the altitude above sea level. The barometer mode displays the current atmospheric pressure and/or a direction the atmospheric pressure is moving. The chronograph mode is used to time an event. The compass mode displays a digital compass that can be used to display a directional heading. The alarm mode is used to set the time at which an alarm will sound. The current modes can be changed to a different mode by pressing the first button 110. The second button 112 when pressed and released turns on the backlight, which illuminates display device 108 for night viewing. In one implementation, holding the second button 112 down for three seconds or more initializes the timepiece 100 setup mode. When in the time mode, the setup mode allows a user to set the time, day and date. If the timepiece 100 is in the compass, barometer or altimeter mode, depressing the second button 112 allows the user to calibrate the compass, the barometer, or the altimeter. The third button 114 and fourth button 116 are used when the timepiece 100 is in the chronograph mode. The third button 114 starts the chronograph and the fourth button 116 stops the chronograph. The buttons 110-116 can have additional or different functions and more or fewer buttons can be used. The buttons 110-116 in one embodiment are used to activate contact switches integrated with the watch module 402. However, buttons 110-116 can be any structure capable of acting as an input device to effect changes to display device 108.

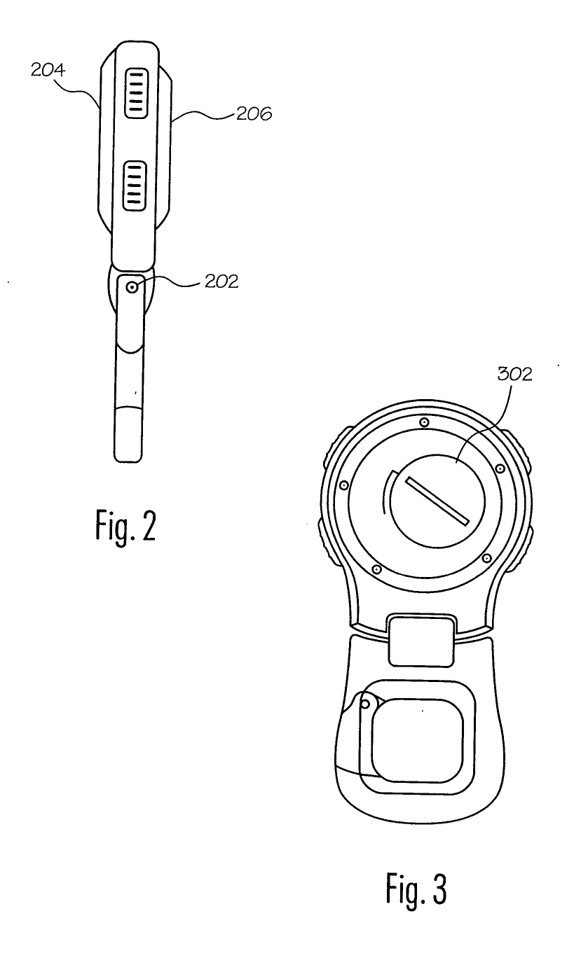

Hinge section 106 connects casing section 102 to attachment section 104. Hinge section 106 is any component or combination of components which enables movement between casing 102 and attachment 104 so that attachment 104 may serve as a stand to maintain casing 102 in an upright position while attachment portion 104 is resting on a substantially horizontal surface. In one embodiment hinge section 106 is formed as part of the casing section 102 and connects to attachment section 104 via post 202 as seen in FIG. 2. This allows attachment section 104 to rotate about post 202. Alternatively, hinge section 106 can be formed as part of attachment section 104 and casing 102 connected to hinge section 106 via a connection post. This arrangement allows casing 102 to rotate about the hinge section 106. Alternatively, both casing 102 and attachment section 104 connect to hinge section 106 via a connection post such that both casing 102 and attachment section 104 are free to pivot about the connection post. Hinge section 106 may also be configured with a release (not shown) to enable the removal of attachment section 104 from casing 102. Hinge section 106, casing 102, and/or attachment section 104 may be further be configured to allow rotation of display device 108 about a horizontal axis, when attachment section 104 is serving as a stand on a horizontal surface.

Attachment section 104 allows timepiece 100 to be attached to and removed from an object of interest such as clothing, backpacks and the like. Attachment section 104 can be any structure capable of connecting timepiece 100 to other objects, such as a clip, a hook, a button or tab and the like. In one embodiment, as seen in FIG. 1, attachment section 104 is in the form of a carabiner clip. Carabiner clips and their operation are well known in the art. As seen in FIG. 1, attachment section 104 includes a gate 130 that pivots about hinge 132 from a closed position to an open position. In one embodiment, hinge 132 is spring loaded so as to return to a closed position automatically after being moved. To attach to an object of interest, the gate 130 is pivoted to an open position. The clip is then passed through a loop or similar structure and gate 130 is moved to a closed position. This secures the timepiece 100 to the object of interest.

Timepiece 100 can be configured in a first configuration that is used when the timepiece 100 is attached to clothing and the like, as seen in FIG. 1. In the first configuration the casing 102 and the attachment section 104 are aligned essentially in the same plane B-B as seen in FIG. 2. Attachment section 104 can be rotated about post 202 towards the back of casing 102 to place timepiece 100 in a second configuration, as seen in FIG. 2. Alternatively, attachment section 104 can pivot toward the front or side of casing 102 to act as a stand for display device 108. The second configuration allows timepiece 100 to maintain display device 108 in relatively upright position while timepiece 100 is resting on a horizontal surface, for example, as a desk or table clock. In the second configuration the casing 102 and the attachment section 104 are at an angle of less than 180° between each other. Typically, for best viewing, the casing 102 makes an angle of 90° or less with the attachment section 104. In a preferred embodiment, the casing 102 makes an angle of 45-90° with the attachment section 104. In the second configuration the attachment section 104 becomes a stand 500 for timepiece 100. The timepiece 100 can then be used as a tabletop clock, as seen in FIG. 5.

Having now described preferred embodiments of the invention modifications and variations may occur to those skilled in the art. The invention is thus not limited to the preferred embodiments, but is instead set forth in the following clauses and legal equivalents thereof.

1. A timepiece comprising:
a casing;
a display device secured by the casing; and
an attachment section pivotally attached to the casing; and
wherein the attachment section is configured to be attachable to an object of interest and pivot in a position to maintain the display device in a substantially upright position when the attachment section is placed on a substantially horizontal surface.

2. The timepiece of claim 1 wherein the display device comprises a watch module.

3. The timepiece of claim 2 wherein the watch module includes one or more modes selected from a group consisting of a time mode, an altimeter mode, a compass mode, a barometer mode, an alarm mode and a chronograph mode.

4. The timepiece of claim 1 wherein the attachment section comprises a carabiner clip.

5. The timepiece of claim 2 further comprising a temperature sensor coupled to the watch module and wherein the display device is operable to display a temperature.

6. An attachable display apparatus comprising:
a casing configured to hold an electronic device having a display; and
an attachment section coupled to the casing and configured to attach and detach with an object of interest;
wherein the casing and the attachment section are coupled such that they move with respect to each other and can be configured to lie essentially in the same plane to form a first configuration and can be configured to form an angle of ninety degrees or less between the attachment section and the casing section to form a second configuration.

7. The apparatus of claim 6 wherein the electronic device comprises a watch module.

8. The apparatus of claim 7 wherein the watch module includes one or more modes selected from the group consisting of a time mode, an altimeter mode, a compass mode, a barometer mode, an alarm mode and a chronograph mode.

9. The apparatus of claim 6 wherein the attachment section comprises a carabiner clip.

10. The apparatus of claim 7 further comprises a temperature sensor coupled to the watch module and wherein the watch module is operative to display an ambient temperature.

11. The apparatus of claim 6 wherein the electronic device comprises one selected from a group consisting of a MP3 player, a multi-function display device, a cell phone, a personal digital assistant, a calculator, and a digital camera.

12. The apparatus of claim 6 further comprising a hinge section configured to connect the attachment section with the casing section in pivoting manner.

13. The apparatus of claim 6 wherein the electronic device includes a multi-function module configured to identify and display an altitude, a temperature, a time, a date, and a compass heading.

14. The apparatus of claim 6 wherein the second configuration maintains the display in an upright position while the attachment section placed on a substantially horizontal surface.

15. The apparatus of claim 6 wherein the electronic device is radio communication device.

16. An apparatus comprising:
an electronic device having a display;
a casing configured to hold the electronic device; and
a clip pivotally attached to the casing, the clip configured to be attachable to an object of interest, the clip configured to be pivoted to form a stand for the apparatus.

17. The apparatus of claim 16 wherein the electronic device comprises a watch.

18. The apparatus of claim 16 wherein the electronic device comprises an altimeter.

19. The apparatus of claim 16 wherein the electronic device comprises a personal audio device.

20. The apparatus of claim 16 wherein the electronic device comprises a radio communication device.

21. The apparatus of claim 16 wherein the electronic device comprises a digital camera.

22. The apparatus of claim 16 wherein the electronic device comprises a calculator.
